(19) United States
(12) Patent Application Publication
(10) Pub. No.: US 2005/0254998 A1
(43) Pub. Date: Nov. 17, 2005

(54) Reactive detection chip and spotter suitable for manufacturing the chip

(75) Inventors: Kenro Nakamura, Kamakura-shi (JP); Masahito Abe, Fujisawa-shi (JP); Naoaki Ogure, Nakano-ku (JP)

Correspondence Address: BROWDY AND NEIMARK, P.L.L.C.;624 NINTH STREET, NW, SUITE 300, WASHINGTON, DC, 20001-5303, US

(73) Assignee: Ebara Corporation, Ohta-ku (JP)

(21) Appl. No.: 11/066,434

(22) Filed: Feb. 28, 2005

(30) Foreign Application Priority Data
Mar. 1, 2004 (JP) 56758/2004
Aug. 12, 2004 (JP) 235221/2004

(51) Int. Cl. G01N 31/22

(52) U.S. Cl. 422/58

(57) ABSTRACT

A reactive detection chip having spots formed by immobilizing a plurality of porous particles in a cluster onto a substrate, the porous particles having probe molecules bound to surfaces of the porous particles and surfaces of pores in the particles including pores, wherein the porous particles are transparent to incident light, and have been immobilized in a single-layered state onto the substrate, is provided. A spotter suitable for spotting a liquid containing low dispersibility particles in manufacturing the reactive detection chip is also provided. In the reactive detection chip, the number of probes can be stably controlled, and a three-dimensional array of the probes uniformizes the supply of a sample to the probes. Thus, the magnitude of signal components is stabilized, and signal components are stably increased, so that the S/N ratio is increased, and the detection capability of the DNA chip can be enhanced. The use of the spotter enables the chip to be manufactured more efficiently.

### BACKGROUND OF THE INVENTION

This invention relates to a reactive detection chip, which enables the recognition of many functional molecules used in genetic diagnosis, physiological function diagnosis, etc., and a spotter suitable for manufacturing the reactive detection chip.

With recent marked progress in biotechnology, reactive detection chips, which enable functional molecules to be recognized, are playing increasingly important roles. Of the reactive detection chips, DNA chips which have recently attracted increased attention are taken as an example for explanation.

Detection of gene mutation, particularly, monobasic polymorphism (mutation of one base in a base sequence), is effective for diagnosis of disease ascribed to mutation or the like, for example, cancer. Detection of such a condition also contributes to the analysis of gene related to etiology of multifactorial disease, and contributes to predictive medicine, and is needed to investigate response to drugs or the severity of side effects in individual persons. Investigation of the situation of gene expression, namely, the situation in which genetic information is read by mRNA, and a corresponding protein is produced, is of crucial importance in understanding vital phenomena and diseases at the gene level, and in developing new drugs. DNA chips are known to be effective as means for gene mutation or the situation of gene expression.

The DNA chip comprises molecules, as probes, which have the property of binding specifically to various DNAs as samples, the probes being arranged and immobilized in corresponding sections on the surface of a carrier. Each of the probes is generally a single-stranded DNA or oligonucleotide having a base sequence complementary to a single-stranded sample DNA.

A sample solution containing the sample DNA is brought into contact with the surface of the DNA chip where the probes have been immobilized, whereby binding between the sample DNA and the corresponding probe is caused. This binding, normally, makes use of hydrogen bonding between paired bases of the probe and the sample DNA, namely, hybridization. If this binding due to hybridization is detected by some means, the sample DNA bound to the probe can be identified and determined.

The contact between the probe and the sample solution is generally performed by the so-called “cover glass method”, a method in which the sample solution is dropped to an area of the carrier surface having the probes immobilized thereon, and the sample solution is uniformly spread by application of a cover glass or the like thereon, for the purpose of permitting a trace amount of the sample solution to act effectively on the probes.

As detecting means for the above method, it is general to addition-react a fluorescent dye molecule as a label with the sample DNA beforehand, and measure the intensity of fluorescence from the fluorescent dye molecule on the sample DNA bound to the probe.

Japanese Patent Application Laid-Open No. 2001-281251 discloses a reactive detection chip comprising porous carrier particles having reactive substances supported on the inside of the pores and surfaces of porous particles, the reactive substances being capable of binding to different objects to be detected, and wherein the porous carrier particles, as integral porous carrier particle probes, are arrayed, bound and immobilized onto one or more of a plurality of micro-segments provided in a substrate, with the reactivity of the inside of the pores and surfaces of the porous carrier particles being maintained. The porous carrier particle probes are used in an embodiment of the present invention.

In preparing the reactive detection chip of such a configuration, the immobilization of the porous particles onto the substrate is usually performed by adding the porous particles to a suitable liquid to form a spotting solution, and spotting a trace amount of the spotting solution onto the surface of the substrate having an adhesive layer formed thereon to form spots comprising a plurality of the porous particles in a cluster. In this case, the porous particles used in the reactive detection chip have large diameters of 1 μm or more, so that it is a key factor to carry out spotting while maintaining their dispersibility.

### SUMMARY OF THE INVENTION

In a reactive detection chip such as a DNA chip, fluorescence to be measured at the time of detection is not limited to fluorescence from the fluorescent dye molecules of the sample DNA hybridized with the probes, namely, “signal components”. The fluorescence measured also includes fluorescent components impairing detection (herein referred to as “noise components”), for example, fluorescence from the fluorescent dye molecules of the sample DNA bound to the substrate and the probes by mechanisms other than hybridization, fluorescence of the substrate itself, fluorescence emitted from dust and dirt adhering to the substrate or contamination, etc. within a measuring optical system, and background signals which the measuring optical system has.

If the sum of such noise components is constant among the respective probes of each DNA chip, the signal components can be derived by subtracting this constant value from the measured fluorescence value. Actually, however, the sum of the noise components is not constant, but shows variations. Moreover, it is virtually impossible to separate the signal components and the noise components accurately in each probe. Accordingly, it is necessary to increase the ratio between the signal components and the noise components (S/N ratio) in the measured fluorescence until the influence of variations in the noise components becomes sufficiently small so that the magnitudinous relationship of the measured fluorescence value agrees reliably with the magnitudinous relationship of the signal components. Particularly with the detection of monobasic polymorphism, which requires discrimination of small differences in the signal components, this increase in the S/N ratio is very important.

A method of increasing the SIN ratio is to decrease the noise components. For this purpose, the confocal method is generally used in measuring fluorescence. Since the confocal method has a narrow focal depth, it shows the action of decreasing fluorescence emitted from a position which is different in height from the probe position by several μm or more. Thus, it can markedly cut the noise components generated from positions different in height from the probes.

With the confocal method, however, correct focus needs to be obtained strictly, so that an expensive fluorescence measuring apparatus of an intricate structure has to be used. An expensive substrate is also needed, since high thickness uniformity is required. Nevertheless, this method is not effective against noise components generated from positions consistent in height with the probes.

Thus, there is a strong demand for a radical method different from the confocal method and arranged to increase the S/N ratio.

Another method for increasing the S/N ratio is to expand the signal components. One of the most effective methods for expanding the signal components is to arrange probes, which have conventionally been arranged two-dimensionally, in a three-dimensional configuration including a direction perpendicular to the substrate, and gather light from three-dimensional sources of signal generation. This idea is inconsistent with the standard confocal method in fluorometry, by which the signal components are collected only from a narrow range with respect to a direction perpendicular to the substrate. Under these circumstances, a DNA chip based on this idea has not been fully developed, and conventional developed products have posed the following problems:
(I) If probes are arranged three-dimensionally, compared with two-dimensionally, it is difficult to stably control the number of the probes per unit projected area of the substrate.
(II) A three-dimensional array, compared with a two-dimensional array, of probes makes it difficult to supply a sample uniformly to the probes, if the cover glass method is used.

Hence, although the probes are arranged three-dimensionally to expand the signal components, detection capability has not been improved, because of great variations in the signal components.

To improve the detection capability, therefore, it is essential to prepare a three-dimensional array of probes which can stably control the number of probes and uniformize the supply of a sample to the probes, thereby stabilizing the magnitude of signal components.

It is an object of the present invention, as described above, to increase signal components stably for raising the S/N ratio, thereby enhancing the detection capability of a DNA chip.

It is another object of the present invention to provide a spotter, which can satisfactorily spot a spotting solution incorporating low dispersibility particles, such as porous particles as used in the present invention, and a reactive detection chip manufactured using the spotter.

The present invention has attained the above-described objects by the following means:
(1) A reactive detection chip having spots formed by immobilizing a plurality of porous particles in a cluster onto a substrate, the porous particles having probe molecules bound to surfaces of the porous particles and surfaces of pores in the particles, wherein the porous particles are transparent to incident light for detection, and the porous particles have been immobilized in a single-layered state onto the substrate.
(2) The reactive detection chip described in (1), which is arranged to detect sample molecules bound to the probe molecules by irradiating the spots with the incident light.
(3) The reactive detection chip described in (1) or (2), wherein the sample molecules have optically detectable molecules added thereto, and which detects the optically detectable molecules.
(4) The reactive detection chip described in (3), wherein the sample molecules have fluorescent dye molecules added thereto, and which detects fluorescence from the fluorescent dye molecules.
(5) The reactive detection chip described in (1), wherein the linear absorption coefficient of the porous particles for the incident light is 10 μm⁻¹ or less.
(6) The reactive detection chip described in (1) or (5), wherein the linear absorption coefficient of the substrate for the incident light is 100 μm⁻¹ or more.
(7) The reactive detection chip described in (1), wherein the particle size of the porous particles is 0.1 μm or more, but 200 μm or less.
(8) The reactive detection chip described in (1), wherein the diameter of the spots comprising the porous particles is 10 μm or more, but 1,000 μm or less.
(9) The reactive detection chip described in (1), which is prepared by forming a thermoplastic organic film on the substrate, applying the porous particles in a spotty form onto the organic film, heating the substrate to soften the organic film, thereby embedding the porous particles in the organic film for immobilizing the porous particles, and removing a surplus of the porous particles which have not been immobilized.
(10) The reactive detection chip described in (9), wherein the thickness of the organic film is smaller than a half of the particle size of the porous particles.
(11) The reactive detection chip described in (9), wherein the organic film is formed by spin-coating a material for the organic film dissolved in an organic solvent.
(12) The reactive detection chip described in (9), wherein the spotty-form application is performed, with the porous particles being dispersed in a liquid.
(13) The reactive detection chip described in (9), wherein the removal of the surplus of the porous particles is performed by ultrasonic cleaning.
(14) The reactive detection chip described in (9), wherein the organic film is a vinyl acetate film.
(15) The reactive detection chip described in (1), wherein the probe molecules are one of a nucleic acid, a protein, and a glycoprotein.
(16) A method for manufacturing a reactive detection chip, comprising the steps of: binding probe molecules to the surface of porous particles and surfaces of pores in the particles to form probe molecule-bearing porous particles; forming a thermoplastic organic film on a substrate; applying the probe molecule-bearing porous particles in a spotty form onto the organic film; heating the substrate to soften the organic film, thereby embedding the probe molecule-bearing porous particles in the organic film for immobilizing the probe molecule-bearing porous particles onto the substrate; and removing a surplus of the probe molecule-bearing porous particles which have not been immobilized.
(17) A spotter comprising a spotting head for spotting a liquid containing a plurality of particles onto a substrate, and a motion-imparting mechanism for imparting a motion to the liquid to maintain a dispersed state of the particles in the liquid.
(18) The spotter described in (17), further comprising a container for accommodating the liquid and supplying the liquid to the spotting head, and wherein the motion-imparting mechanism imparts the motion to the liquid in the container.
(19) The spotter described in (17), wherein the motion-imparting mechanism moves the spotting head accommodating the liquid.
(20) The spotter described in (18), wherein the motion includes vibrations in a vertical direction.
(21) The spotter described in (18), wherein the motion includes rotations in a vertical plane.
(22) The spotter described in (18), wherein the motion includes upside-down turns.
(23) The spotter described in (18), wherein the motion-imparting mechanism feeds a gas into the liquid accommodated in the container for bubbling, thereby maintaining the dispersed state of the particles in the liquid.
(24) The spotter described in (18), wherein the motion-imparting mechanism is a magnetic stirrer for rotating a rotor disposed in the container to stir the liquid in the container.
(25) A reactive detection chip prepared using the spotter described in (17).
(26) A method for arranging particles, comprising making ready for use a liquid incorporating a plurality of particles,
imparting a motion to the liquid to maintain a dispersed state of the plural particles in the liquid so that the plural particles do not agglomerate, and
arranging the liquid containing the plural particles on a substrate with the use of a spotting head.

### BRIEF DESCRIPTION OF THE DRAWINGS

FIG. 1 is a sectional view illustrating the step of immobilizing probe-bearing porous particles onto a substrate.

FIG. 2 is a sectional view illustrating a step succeeding the step of FIG. 1.

FIG. 3 is a sectional view illustrating a step succeeding the step of FIG. 2.

FIG. 4 is a sectional view illustrating a step succeeding the step of FIG. 3, and an explanation drawing showing probes immobilized onto porous particles.

FIG. 5 is a spot constituted of the probe-bearing porous particles.

FIG. 6 is a array drawing of the spots in a DNA chip according to the present embodiment.

FIG. 7 is a sectional view of a DNA chip comprising two-dimensionally arranged probes.

FIG. 8 is a sectional view of a spot comprising oligonucleotide-bearing porous glass particles immobilized in a stacked form.

FIG. 9(a) is a schematic plan view showing a spotter according to a first embodiment of the present invention.

FIG. 9(b) is a schematic side view of the spotter shown in FIG. 9(a).

FIG. 10 is an enlarged sectional view of a spotting head shown in FIG. 9(b).

FIG. 11(a) is a front view showing an upside-down turning mechanism of a spotting head in a third embodiment of the spotter according to the present invention.

FIG. 11(b) is a side view showing the upside-down turning mechanism of the spotting head shown in FIG. 11(a).

FIG. 12 is a sectional view showing a spotting head in a fourth embodiment of the spotter according to the present invention.

FIG. 13(a) is a front view showing a rotating mechanism of a spotting head in the fourth embodiment of the spotter according to the present invention.

FIG. 13(b) is a side view showing the rotating mechanism of the spotting head shown in FIG. 13(a).

FIG. 14 is a sectional view showing a container in a fifth embodiment of the spotter according to the present invention.

FIG. 15 is a sectional view showing a container and a magnetic stirrer in a sixth embodiment of the spotter according to the present invention.

### DETAILED DESCRIPTION OF THE INVENTION

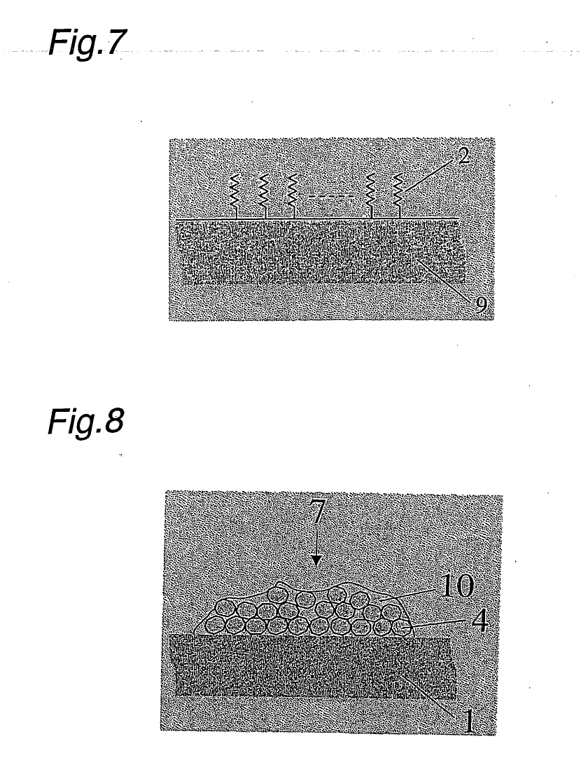

In an ordinary DNA chip, probes are directly immobilized on a flat substrate. Thus, the array of the probes is two-dimensional (see FIG. 7). If the array of the probes can be rendered three-dimensional so that the probes are distributed not only in a direction parallel to the surface of the substrate, but also in a direction perpendicular to the surface of the substrate, the number of the probes per unit projected area on the surface of the substrate will be remarkably increased. Thus, if signals, with respect to the direction perpendicular to the surface of the substrate, from the sample bound to the probes can be collected, it becomes possible to increase the signal components by arranging the probes three-dimensionally.

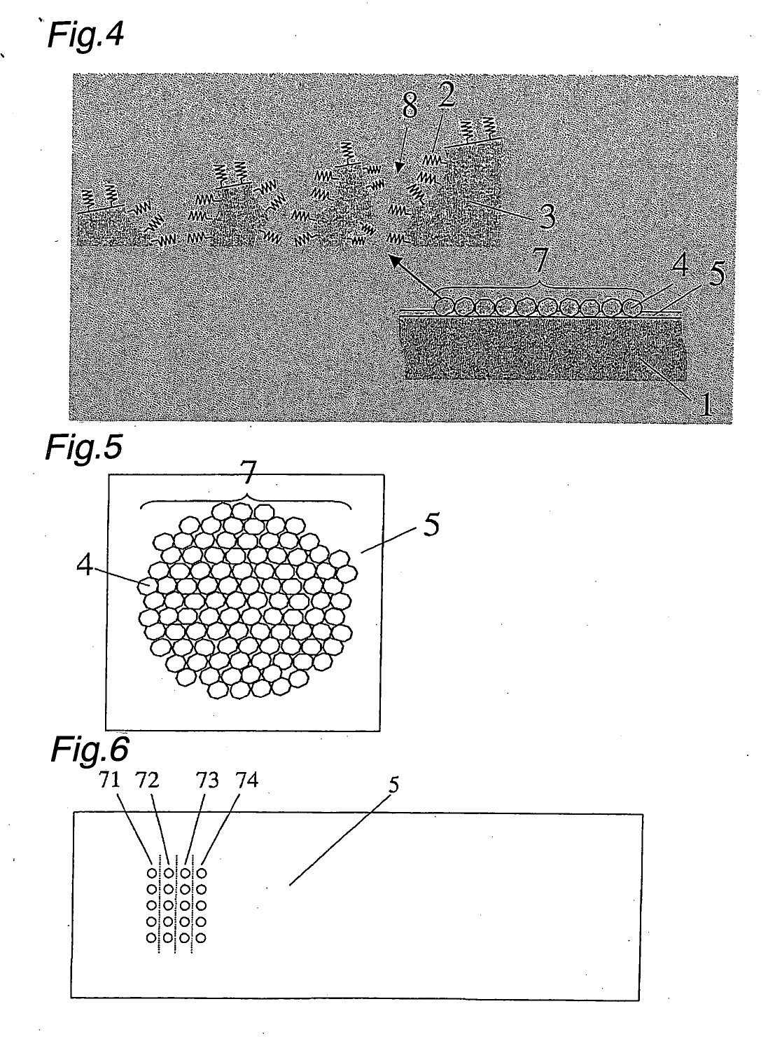

In order to render the probe array three-dimensional, the means disclosed in the aforementioned Japanese Patent Application Laid-Open No. 2001-281251 is used. That is, porous particles are used as carriers of probes, and the probes are bound to all surfaces of the porous particles including the inside pores. The resulting probe-bearing porous particles are immobilized on a substrate to form a spot of a reactive detection chip (see FIG. 4). Since a sample can diffuse to the inside of the porous particles via the pores, the probes present inside the porous particles can also contribute to their binding reaction with the sample.

Next, a method for gathering signals from the sample bound to the probes inside the porous particles is presented. These signals are response light appearing when incident light is shone at an optically detectable label substance, generally, a dye, which has been addition-reacted with the sample beforehand, as in the currently standard method of detection in DNA chips. It is common practice to select a fluorescent dye as this dye, shine exciting light as incident light, and detect fluorescence as response light.

In the case of the sample bound to the probes inside the porous particles, in order to excite the fluorescent dye addition-reacted with the sample, namely, the fluorescence label, exciting light is shone through the media which are the porous particles. Thus, if porous particles transparent to exciting light are selected, exciting light passes through the porous interior without attenuation, and shines the fluorescence label. The wavelength of fluorescence excited by shining of exciting light is longer than the wavelength of exciting light by only 20 nm or so, which is a small difference from the wavelength of exciting light. Thus, the transmission of fluorescence through the porous particles is nearly equal to the transmission of exciting light through the porous particles and, if the porous particles are transparent to exciting light, it would be reasonable to think that they are also transparent to fluorescence. Hence, excited fluorescence also passes through the porous interior without attenuation. By so selecting the porous particles transparent to exciting light, it becomes possible to gather signals from the fluorescence label over the entire interior of the porous particles, thus eventually making it possible to increase signal components.

Finally, a proposal will be made for a method of controlling the number of probes increasing three-dimensionally, and uniformizing the supply of the sample to the probes, thereby stabilizing the magnitude of the signal components.

Control of the number of the probes is achieved by suppressing variations in thickness among the spots. Since the number of the probes per unit projected area on the substrate is proportional to the thickness of the spot, the magnitude of the signal components is proportional to the thickness of the spot.

To uniformize the supply of the sample to the probes, it is necessary to work out a spot form suitable for the cover glass method used in the binding reaction, namely, a method by which a trace amount of a sample solution dropped to a spot portion of the substrate is covered with a cover glass for spreading the sample solution uniformly. This is because uniformalization of the thickness of the layer of the sample solution spreading on the spots is essential for a uniform binding reaction.

In connection with the immobilization of the probe-bearing porous particles onto the substrate, the aforementioned Japanese Patent Application Laid-Open No. 2001-281251, for example, illustrates a method for applying a paste, which has the above particles dispersed in a sol or a polymer, spottily onto a substrate for immobilization. Some sols or polymers, when solidified, turn into a network structure in which sample molecules can diffuse. In this case, the sample molecules can reach the probes. A sol or polymer, which becomes transparent upon further solidification and whose self-fluorescence is small, does not impair the measurement of fluorescence intensity.

However, the problem with this method is that the thickness of the spot, i.e., the number of the probe-bearing porous particles in the thickness direction of the spot, cannot be controlled. If this method is carried out, the spot is necessarily constructed of a stack of the probe-bearing porous particles. The thickness and cross-sectional shape of the spot are difficult to control stably, even if the concentration of those particles in the paste or the amount of the spottily applied paste is rendered constant. In short, this method leads to great variations, inter-spot and intra-spot, in the thickness of the spot.

Since the thicknesses of the spots are subject to variations, the spacings between the lower surface of the cover glass and the upper surfaces of the spots are not constant, even when the cover glass method is employed. As a result, the thickness of the layer of the sample solution spreading on the spots is not uniform. Thus, variations emerge in the manner of penetration of the sample solution, with the result that the binding reaction between the probes and the sample is ununiform. Moreover, even if the sample solution sufficiently penetrates and reaches the probes, fluctuations in optical transmission take place, because the thicknesses of the probe-bearing porous particles and the immobilizing paste layer, through which fluorescence passes, are different according to locations. Consequently, fluorescence intensity observed from the outside shows marked variations.

Because of the above-mentioned disadvantages, the method of stacking the probe-bearing porous particles for immobilization is not suitable for the cover glass method used in the binding reaction.

Thus, it becomes necessary to adopt a method in which the probe-bearing porous particles are arranged in a single layer and immobilized onto a substrate so that the thickness of the spots is constant. For this purpose, it is optimal to form an adhesive layer on the substrate, and embed the probe-bearing porous particles in the adhesive layer for immobilization.. The thickness of the adhesive layer is set at not more than a half of the particle size of the probe-bearing porous particle so that a half or more of the volume of the probe-bearing porous particle is exposed to the outside of the adhesive layer and this exposed region can directly contact the sample solution.

A concrete method of manufacturing is as follows: A thermoplastic organic film, as an adhesive layer, is formed on a substrate by spin coating or the like, and probe-bearing porous particles dispersed in a liquid are applied in a spotty form onto the organic film. The substrate is heated to soften the organic film, thereby embedding the probe-bearing porous particles in the softened organic film. The substrate is cooled to harden the organic film. Then, a surplus of the probe-bearing porous particles superposed on the immobilized probe-bearing porous particles is removed by ultrasonic cleaning or the like.

In this manner, spots comprising the probe-bearing porous particles arranged in a single layer and immobilized on the substrate are formed. The resulting spots are reduced in thickness variations. This makes it possible to control the number of the probes per unit area of projection onto the substrate, and to use, without any problem, the cover glass method used in the binding reaction.

The transparency of the porous particles should be as high as possible, and their linear absorption coefficient for exciting light is desirably 10 μm⁻¹ or less. Roughly speaking, this value means that exciting light can penetrate the interior of the porous particles to a depth of the order of 0.1 μm or more. The average spacing between the probe molecules is generally several tens of nanometers. If the transparency is lower than this value, therefore, the number of the probes present within the exciting light penetration distance will be a few or less. As a result, there will be a low effect of signal integration (or accumulation) in the direction of exciting light penetration, i.e., the direction perpendicular to the surface of the substrate.

According to the present invention, signals from the fluorescence label throughout the interior of the transparent porous particles is integrated. Thus, particularly when the particle size of the porous particles exceeds 10 μm, the use of the confocal method should be avoided in performing fluorescence detection. The reason is that the focal depth in the confocal method is narrow, and thus, with respect to the direction perpendicular to the substrate, signals can be integrated only from a region of several micrometers.

From the viewpoint of increasing the S/N ratio, it is also important to decrease the fluorescence of the substrate itself that is one of noise components. In conventional DNA chips as well, a slide glass with small self-fluorescence has been used as the substrate. In the present invention, care should be taken to integrate fluorescence in the transparent substrate, for the same reason as the reason why fluorescence is integrated in the probe-bearing transparent porous particles. Even if the transparent substrate is composed of a material with small self-fluorescence, there is a concern that noise components will increase under the influence of the integration. Accordingly, the substrate is required to be opaque in reply to a conventional demand that it be low in self-fluorescence for exciting light. Concretely, its linear absorption coefficient is preferably 100 μm⁻¹ or more.

With the conventional DNA chip, glass has been preferred as a material for the substrate in consideration of the ease of binding, because probe molecules are to be directly immobilized onto the substrate. In the present invention, on the other hand, probe molecules are immobilized on porous particles, and the substrate plays a role in immobilizing the porous particles thereon via an adhesive layer. Thus, the material for the substrate is not limited to glass. Since the confocal method is not used, moreover, the high uniformity of the substrate thickness is not required. Given the condition that the substrate be opaque, the range of substrate selection widens as compared with conventional DNA chips.

The particle size of the porous particles is desired to be 0.1 μm or more, but 200 μm or less, preferably 0.1 μm or more, but 100 μm or less, more preferably 1 μm or more, but 10 μm or less, as disclosed in Japanese Patent Application Laid-Open No. 2001-281251. The average spacing between the probe molecules is generally several tens of nanometers. If the particle size is less than 0.1 μm, therefore, the number of the probes present within the exciting light penetration distance will be a few or less. As a result, there will be a low effect of signal integration (accumulation). This is of no meaning.

If the particle size exceeds 200 μm, disadvantages occur when the binding reaction between the probes and the sample is produced. The reason will be offered below.

In performing hybridization which is the binding reaction between DNA probes and a DNA sample, it is common practice to use the cover glass method for the purpose of causing a trace amount of a sample solution to act on the probes effectively. Since the sample solution is difficult to acquire and is precious, the amount of the sample solution used per DNA chip is 40 μl or less, usually on the order of 10 μl. If 10 μl of the sample solution is dropped on the spot portion of the substrate, and a cover glass 20 mm square is placed thereon to spread the sample solution uniformly, the sample solution is interposed, as a 25 μm thick liquid layer, between the substrate and the cover glass. The thickness of the liquid layer varies with the amount of the sample solution and the size of the cover glass, but is usually at most on the order of several tens of micrometers. If the particle size is larger than 200 Mm, and the spot protrudes beyond 200 μm from the substrate, the application of the cover glass does not result in a uniform spread of the sample solution, but produces differences in the way of contact with the sample solution among the spots. Thus, the particle size is desirably 200 μm or less, from the point of view of applicability to the cover glass method.

### EMBODIMENTS FOR PRACTICING THE INVENTION

First of all, a fluorescent dye for labeling sample molecules is decided on. Porous particles, whose linear absorption coefficient for exciting light for exciting the fluorescent dye is 10 μm⁻¹ or less, are selected as carriers of probes.

This linear absorption coefficient reflects the optical characteristics inherent in the constituent of the porous particles, as well as their feature as a porous material, and depends on the pore size, pore volume, etc. of the porous particles.

Examples of the fluorescent dye are FITC (fluorescein isothiocyanate), Cy3, and Cy5. The wavelength of exciting light necessary for exciting these fluorescent dyes is within the range of 450 to 650 nm. Thus, candidate porous particles are those transparent to visible light. Porous particles comprising glass, or a transparent plastic, such as polypropylene or polystyrene, are optimal from the viewpoint of possessing both of surface properties and chemical stability preferred as the carrier of probes.

The particle size of the porous particles is set at 0.1 μm or more, but 200 μm or less, preferably 0.1 μm or more, but 100 μm or less, more preferably 1 μm or more, but 10 μm or less, as stated earlier. The pore size of the porous particles should empirically be set at 10 nm or more, but 200 nm or less, more preferably 50 nm or more, but 100 nm or less.

Then, probe molecules are bound to the porous particles. This is performed in accordance with a publicly known method, namely, performed by immersing the porous particles, to which a linker has been joined by surface treatment, in a solution of probe molecules modified at the terminal in such a manner as to be bound to the linker.

Alternatively, it is possible to employ a technique for directly chemically synthesizing probe molecules on the surfaces of the porous particles. In the case of oligonucleotide probe molecules, for example, an established synthesis method such as the phosphoamidite process is present.

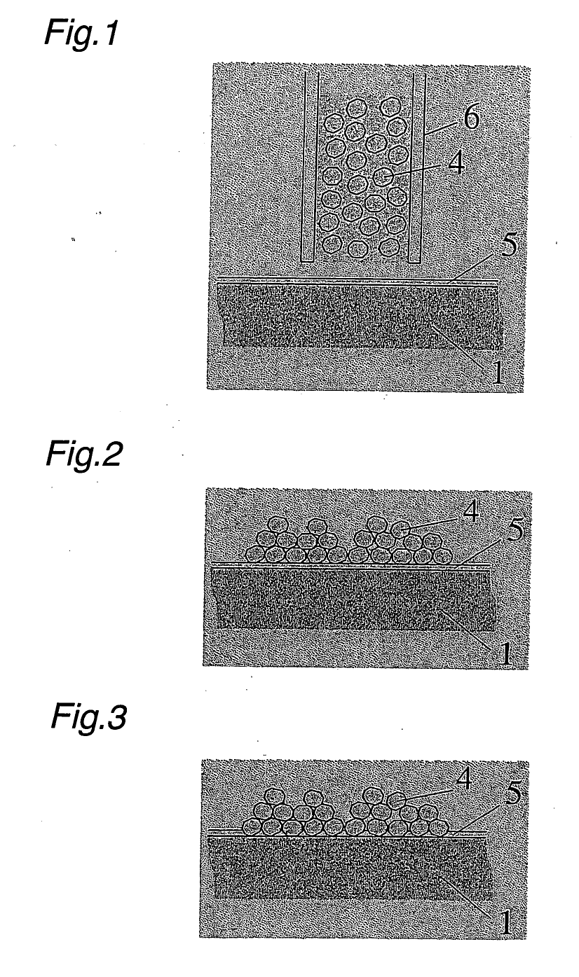

Next, the steps of immobilizing the probe molecule-bound porous particles onto a substrate will be described with reference to FIGS. 1 to 5. A plate, which is opaque to exciting light and has a size of 25 mm×75 mm and a thickness of 1 mm, is made ready for use as a substrate 1. A silicon plate, a metal plate, or a plastic plate opaque in the visible light region can be used.

On the substrate 1, a thermoplastic organic film 5 is formed as an adhesive layer for immobilizing thereon porous particles 3 to which probes 2 have been bound, namely, probe-bearing porous particles 4. A preferred method of its formation is to dissolve a material for the organic film 5 in an organic solvent to form a solution with appropriate viscosity, and spin-coating the solution. The requirements of the material for the organic film 5 are small self-fluorescence, high adhesion to the substrate 1, strong adhesive force for the probe-bearing porous particles 4, and water resistance not impairing a hybridization reaction. Concretely, vinyl acetate, polyvinyl alcohol, vinyl chloride, or synthetic rubber can be used.

As shown in FIG. 1, the probe-bearing porous particles 4 dispersed in a liquid, such as water, are spotted on the organic film 5 by a suitable spotter 6 to be described later. At this stage, the probe-bearing porous particles 4 are a stacked cluster, as shown in FIG. 2.

After the liquid contained in this cluster evaporates, the substrate 1 is heated in a horizontal posture to embed the probe-bearing porous particles 4 in the softened organic film 5. The heating is performed by raising the atmospheric temperature surrounding the substrate 1 with the use of a thermostat. If a material with high thermal conductivity, such as a silicon plate or a metal plate, is used as the substrate 1, it can be heated with a hot plate. The heating temperature and the heating time are determined according to the type of the organic film 5. If the organic film 5 is a vinyl acetate film, the heating temperature of 100° C. and the heating time of 10 minutes are appropriate. Upon such heat treatment, the probe-bearing porous particles 4 spontaneously sink in the softened organic film 5 and arrive at the substrate surface.

At a stage where the organic film 5 has solidified upon cooling, the probe-bearing porous particles 4 embedded in the organic film 5 are immobilized on the substrate 1. Then, the probe-bearing porous particles 4, which have been superposed, although not immobilized, on the immobilized probe-bearing porous particles 4, are excluded by ultrasonic cleaning or the like in water, and the substrate 1 is dried by an air gun or the like.

In this manner, a spot 7, which comprises the probe-bearing porous particles 4 arranged, without gap, in a single layer and immobilized on the substrate 1, is completed. A sectional view of the spot 7 is shown in FIG. 4, and its plan view is shown in FIG. 5. To visualize a state in which the probes 2 are bound to pores 8 of porous particles 3, a partial enlarged view of the probe-bearing porous particles 4 is also shown in FIG. 4. Since the probe-bearing porous particles 4 are not superposed, but arranged in a single layer, the thickness of the spot 7 is stable, and the number of the probes 2 in a direction perpendicular to the surface of the substrate 1 can be controlled stably. The diameter of the spot 7 is not less than 10 times the particle size of the probe-bearing porous particle 4, and may be determined within the range of 10 to 1,000 μm according to the spot density required for each DNA chip. Preferably, the diameter of the spot 7 is 50 to 1,000 μm, more preferably 100 to 500 μm. The number of the probe-bearing porous particles 4 constituting the spot 7 is at least about 100. Thus, even if there is some variation in the particle diameter of the probe-bearing porous particles 4, the varying diameter is averaged at the level of the spot 7, so that variations in thickness among the spots 7 can be said to be extremely small. Moreover, some degree of variation is permitted for the number of the probe-bearing porous particles 4 constituting the spot 7. The reason is that the fluorescence intensity of the spot 7 depends not on the total projected area of the spot 7 to the substrate 1, but on the number of the probes 2 per unit projected area.

During immobilization, if the whole of the probe-bearing porous particles 4 is embedded in the organic film 5, binding of the sample to the probes 2 is impossible. Thus, in order to cause a half or more of the volume of the probe-bearing porous particle 4 immobilized in contact with the substrate surface to be exposed to the outside, the thickness of the organic film 5 is set at a half or less of the particle size of the probe-bearing porous particle 4. If sufficient immobilization strength is obtained, the thickness of the organic film 5 is preferably rendered small, from the viewpoint of increasing the penetration area of the sample into the probe-bearing porous particles 4, or from the viewpoint of increasing self-fluorescence.

An explanation will now be offered for the shape of the-aforementioned spotter which is preferred in spotting the dispersion of the probe-bearing porous particles onto the substrate when manufacturing the DNA chip of the present invention.

The spotter of the present invention can prevent the agglomeration of the particles contained in the spotting solution by imparting a motion to the spotting solution. Thus, the spotter of the present invention can maintain the dispersed state of the particles without adding an additive to the spotting solution. In the fields of biotechnology and nanotechnology, such as reactive detection chips, which are the most important fields of application of the spotter of the present invention, the amount of the spotting solution is of the order of 1 ml, a very small amount. In order to impart a motion to the spotting solution, therefore, the preferred method would be to move the spotting head, or move a container accommodating the spotting solution, or perform micro-bubbling of the spotting solution, or stir the spotting solution with the use of a micro-magnetic stirrer.

The particles in the spotting solution settle by the action of gravity. Thus, in order to make up for the settlement of the particles and maintain the dispersed state of the particles, it is important to give a vertical upward motion component to the particles. Examples of the motion are vibrations in the vertical direction, circular motion (rotation) in a vertical plane, and upside-down turning movement. Bubbling can be performed by feeding a gas from the bottom of the container into the spotting solution. Stirring by a magnetic stirrer can be performed by using a very small rotor which is sufficiently accommodated at the bottom of a small container used for this usage. When moving the spotting head and the container, it is preferred to switch between two types of motions (vibrations), i.e., strong vibrations for redispersing the particles which have settled and deposited at the bottom of the container, and weak vibrations for maintaining the state of the particles once dispersed.

In this manner, the reactive detection chip of the present invention is completed. The amount of protrusion of the spots from the substrate is equivalent to one layer of the porous particles with a particle size of 200 μm or less. In this reactive detection chip, therefore, it is possible to cause a uniform binding reaction by use of the cover glass method that is usually carried out for uniformly spreading a trace amount of a sample solution over the spot portion. In connection with cleaning after reaction and detection, exactly the same handling as that for conventional reactive detection chips can be effected.

### EXAMPLES

The present invention will be described in more detail by the following Examples and Comparative Examples, with a DNA chip using oligonucleotide probes being taken as an example. However, the present invention is not limited to these examples.

### Example 1

FITC (fluorescein isothiocyanate) was used as fluorescence labeling molecules for a sample. The corresponding exciting wavelength was 494 nm, and fluorescence wavelength was 518 nm.

Porous glass particles having a particle size of 7 μm, a pore size of 50 nm, and a pore volume of 1.3 ml/g were selected as carriers of oligonucleotide probes. The porous glass particles were measured for absorbance, and their linear absorption coefficient at a wavelength of 494 nm was found to be 0.1 μm⁻¹. This value fulfilled the requirement of 10 μm⁻¹ or less, and meant sufficiently high transparency. To synthesize oligonucleotide probes directly on the porous glass particles and support the probes on these particles, the following method disclosed in Japanese Patent Application Laid-Open No. 2002-254558 was used:

The porous glass particles were immersed in a solution of N-(2-aminoethyl)-3-aminopropyltrimethoxysilane in toluene. The solution was held at a temperature of 110° C. for several hours to introduce amino groups into the surfaces of the porous glass particles. The aminated porous glass particles were immersed in an acetonitrile solution of β-cyanoethyl phosphoamidite corresponding to the first nucleotide of an oligonucleotide to bind the first nucleotide to the particles. Then, an oligonucleotide strand corresponding to each probe was synthesized by the ordinary phosphoamidite method. The synthetic oligonucleotide strand-bearing porous glass particles were immersed in aqueous ammonia for more than 10 hours to remove the protective groups remaining in the strand. As a result, oligonucleotide probe-bearing porous glass particles were completed.

DNA fragments containing codon 248 of the tumor suppressor gene p53 were selected as samples whose detection was to be confirmed, and three types of samples were prepared: a normal type, and two mutation types formed by point mutation of the codon 248, i.e., mutation type 1 and mutation type 2. These samples were each FITC-labeled at the 3′-terminal, and had the following structures:

Normal type sample:
5′ AT GGG CCT CCG GTT CAT GCC 3′-FITC
Mutation type 1 sample:
5′ AT GGG CCT CCA GTT CAT GCC 3′-FITC
Mutation type 2 sample:
5′ AT GGG CCT CTG GTT CAT GCC 3′-FITC

In correspondence with these samples, the following complementary strand probes and non-complementary negative control probe were directly synthesized and supported on the porous glass particles by the aforementioned method:

Normal type probe:
PG-3′ TA CCC GGA GGC CAA GTA CGG 5′
Mutation type 1 probe:
PG-3′ TA CCC GGA GGT CAA GTA CGG 5′
Mutation type 2 probe:
PG-3′ TA CCC GGA GAC CAA GTA CGG 5′
Negative control probe:
PG-3′ TT TTT TTT TTT TTT TTT TTT 5′

A, C, G and T signify four bases, adenine, cytosine, guanine and thymine, bound to the sugar residue, and PG denotes porous glass particles.

Next, the process for immobilizing the oligonucleotide probe molecule-bound porous glass particles onto a substrate will be described with reference to FIGS. 1 to 5. An acetone solution of vinyl acetate was spin-coated on a silicon substrate 1, which has dimensions 25 mm×75 mm, and a thickness of 0.73 mm corresponding to the size of a slide glass and which was completely transparent to an exciting wavelength of 494 nm, to form a vinyl acetate layer 5 about 3 μm in thickness. The vinyl acetate layer 5 plays the role of an adhesive layer for immobilizing porous glass particles 3 having oligonucleotide probes 2 bound thereto, namely, oligonucleotide probe-bearing porous glass particles 4, onto the silicon substrate 1.

Then, as shown in FIG. 1, a dispersion comprising each of the various oligonucleotide probe-bearing porous glass particles 4 dispersed in water was spotted on the vinyl acetate layer 5 with the use of a spotter 6 presented in [Example 2]. At this time, the vinyl acetate layer 5, as will be clear from subsequent steps, may be completely dry, and this applies for an adhesive layer of other material. Thus, the adhesive layer-coated substrate can be prepared and stored in advance, and is advantageous for mass production.

At a stage immediately after spotting, the oligonucleotide probe-bearing porous glass particles 4 were a stacked cluster, as shown in FIG. 2.

After water contained in this cluster evaporated, the silicon substrate 1 was heated in a horizontal state by a thermostat for 10 minutes at 100° C. in an atmosphere of air. The vinyl acetate layer 5 was softened thereby, whereupon the oligonucleotide probe-bearing porous glass particles 4 were embedded in the vinyl acetate layer 5, as shown in FIG. 3. After the vinyl acetate layer 5 solidified upon cooling, the silicon substrate was ultrasonically cleaned in water for 1 minute at a frequency of 28 kHz to remove the surplus oligonucleotide probe-bearing porous glass particles 4, which were not immobilized on the vinyl acetate layer 5, from above the silicon substrate 1. Then, the silicon substrate 1 was dried by an air gun to complete a spot 7 which comprised the oligonucleotide probe-bearing porous glass particles 4 immobilized in a single layer onto the silicon substrate 1. A sectional view of the spot 7 is shown in FIG. 4, and its plan view is shown in FIG. 5. To visualize a state in which the oligonucleotide probes 2 were bound to pores 8 of the porous glass particles 3, a partial enlarged view of the oligonucleotide probe-bearing porous glass particles 4 is also shown in FIG. 4. Since the thickness of the vinyl acetate layer 5 was not more than a half of the particle size of the oligonucleotide probe-bearing porous glass particle 4, a half or more of the volume of this particle was exposed to the outside of the vinyl acetate layer 5. This exposed zone can directly contact a sample solution.

The size of the spot 7 was about 1,000 μm. Five spots of each of 4 types, i.e., a spot 71 corresponding to the above-mentioned normal type probe, a spot 72 corresponding to the mutation type 1 probe, a spot 73 corresponding to the mutation type 2 probe, and a sport 74 corresponding to the negative control probe, were arranged on the vinyl acetate layer 5 in a lattice pattern of uniform squares, with spacing of 2,000 μm being provided between the adjacent spots, as shown in FIG. 6.

The so prepared DNA chip can be handled in the same manner as that for ordinary DNA chips.

The aforementioned three samples were each diluted with a hybridization buffer solution to prepare 3 sample solutions. Each of the sample solutions was dropped in an amount of 10 μl onto the spot zone of each of 3 of the DNA chips, and a cover glass 20 mm square was placed thereon to spread the sample solution uniformly.

Then, the substrate was accommodated in a hybridization chamber, and kept at 45° C. for 12 hours in a thermostat for incubation.

Then, the substrate was withdrawn from the chamber, dipped in a primary cleaning-solution having 0.01% SDS dissolved in a 2×SSC solution, and stripped of the cover glass. Then, the substrate was cleaned, while rocked, for 5 minutes in the primary cleaning solution.

Then, the substrate was dipped in a secondary cleaning solution having 0.01% SDS dissolved in a 0.2×SSC solution, and was cleaned, while rocked, for 5 minutes in the secondary cleaning solution.

Then, the substrate was dipped in a 0.2×SSC solution, and rinsed, while rocked, for 1 minute in order to remove SDS.

After rinsing, the substrate was dried by an air gun.

The spots on the substrate after completion of the above-described hybridization were observed under an ordinary fluorescence microscope, and the fluorescence intensities of the respective spots were measured.

The brightnesses of pixels of digitized spot images were averaged to calculate the fluorescence intensity of each spot. The values of the five spots comprising the probes of the same type were averaged to determine the fluorescence intensities of the respective probes for each sample. The results are shown in Table 1.

TABLE 1
Spot fluorescence intensities in DNA chip of the present invention

Probe

| | Normal | Mutation | Mutation | Negative |
|---|---|---|---|---|
| Sample | type | type 1 | type 2 | control |
| Normal | 180.1 | 109.3 | 121.9 | 37.1 |
| type | | (1.65) | (1.48) | |
| Mutation | 118.7 | 150.3 | 82.2 | 38.3 |
| type 1 | (1.27) | | (1.83) | |
| Mutation | 127.1 | 91.2 | 183.6 | 37.5 |
| type 2 | (1.44) | (2.01) | | |

For each sample, the ratio between perfect matching fluorescence intensity and mismatching fluorescence intensity, namely, the discrimination ratio, is described in the parentheses. For the normal type sample, the normal type probe shows perfect matching, while the mutation type 1 probe and the mutation type 2 probe show mismatching. For the mutation type 1 sample, the mutation type 1 probe shows perfect matching, while the normal type probe and the mutation type 2 probe show mismatching. For the mutation type 2 sample, the mutation type 2 probe shows perfect matching, while the normal type probe and the mutation type 1 probe show mismatching. The inside of the frame corresponding to perfect matching is shaded. In each sample, perfect matching gives greater hybridization strength than mismatching, and ought to give higher fluorescence intensity. Accordingly, the discrimination ratio is greater than 1, and the higher this value, the higher the detection capability is.

Table 1 shows that the six discrimination ratios all exceed 1, demonstrating that point mutation can be identified.

In connection with the perfect matching in the shaded frames, all combinations show fluorescence intensities of more than 150. In mismatching in the frames other than the shaded frames, the fluorescence intensity is 127 at the highest, a value significantly lower than those for perfect matching. In this respect as well, point mutation can be sufficiently identified.

The spot fluorescence intensity of the negative control probe is deemed to consist only of noise components, since it does not include signal components due to hybridization. The main cause of noise is considered to be so-called nonspecific adsorption mechanisms of sample molecules other than normal hybridization. This is assumed to include cases where sample molecules mechanically adhere to the probe molecules themselves or directly adhere to the porous particles, mainly owing to an insufficient cleaning operation.

As shown in Table 1, noise components are estimated at 37.6 based on the average of the spot fluorescence intensities of the negative control probe-for the three samples. The spot fluorescence intensities in perfect matching for the three samples average 171.3. Thus, signal components are calculated as 133.7 (=171.3−37.6). Hence, the S/N ratio turns out to be 3.56 (=133.7/37.6). Variations in the signal components for the spot of the same type were examined, with the noise components being fixed, showing that the relative standard deviation was 5.5%.

### Comparative Example 1

With the aim of comparing the present invention with a DNA chip of a two-dimensional probe array, a two-dimensional DNA chip was prepared by directly immobilizing probes 2 on the surface of a slide glass 9, as shown in FIG. 7. Using an ordinary spotting method, the aforementioned synthetic probe molecules amino-modified at the terminal were immobilized by covalent bonding onto an active ester-treated slide glass. The spot diameter and the spot arrangement were the same as those in the Examples of the present invention.

The same hybridization as in the present invention was performed, and the fluorescence intensities of the respective spots were numerically obtained. The results are shown in Table 2.

TABLE 2
Spot fluorescence intensities in DNA chip
with a two-dimensional probe array

Probe

| | Normal | Mutation | Mutation | Negative |
|---|---|---|---|---|
| Sample | type | type 1 | type 2 | control |
| Normal | 35.4 | 33.6 | 32.2 | 30.6 |
| type | | (1.05) | (1.10) | |
| Mutation | 34.6 | 37.2 | 33.0 | 31.2 |
| type 1 | (1.08) | | (1.13) | |
| Mutation | 34.5 | 34.6 | 35.5 | 30.2 |
| type 2 | (1.03) | (1.03) | | |

The fluorescence intensities in the shaded frames corresponding to perfect matching in Table 2 show no significant differences from the other fluorescence intensities corresponding to mismatching.

The six discrimination ratios all exceed 1, but their differences from 1 are small, compared with the present invention, making identification of mutation impossible. Furthermore, the contradiction arises that the signal components found in the same manner as for the present invention average 5.3, while the noise components average 30.7, a value much greater than the value of the signal components.

### Comparative Example 2

With the aim of comparing the present invention with a DNA chip which is produced by a conventional manufacturing method and in which the probe array is three-dimensional, but signal components have not been controlled, there was produced a DNA chip comprising spots having oligonucleotide probe-bearing porous glass particles arranged not in a single-layer state, but in a stacked condition, thus having an uncontrolled thickness. Concretely, oligonucleotide probe-bearing porous glass particles 4 were dispersed in a silica sol 10, and the dispersion was immobilized spottily on a silicon substrate 1 to form spots 7 having a cross-sectional shape shown in FIG. 8. The cross-sectional shape of the spot 7 was an irregular convex shape, and a thick portion of the spot 7 comprises about 3 layers to about 6 layers of the oligonucleotide probe-bearing porous glass particles 4, showing variations among the spots. Using the same spot size and spot arrangement as those in the present invention, the same hybridization as in the present invention was performed, and the spot fluorescence intensities were measured. The results are shown in Table 3.

TABLE 3
Spot fluorescence intensities in DNA chip
with an uncontrolled spot thickness

Probe

| | Normal | Mutation | Mutation | Negative |
|---|---|---|---|---|
| Sample | type | type 1 | type 2 | control |
| Normal | 231.1 | 209.7 | 190.7 | 57.6 |
| type | | (1.10) | (1.21) | |
| Mutation | 235.9 | 240.2 | 160.3 | 62.4 |
| type 1 | (1.02) | | (1.50) | |
| Mutation | 239.1 | 192.3 | 248.9 | 53.5 |
| type 2 | (1.04) | (1.29) | | |

The six discrimination ratios all exceed 1, but their differences from 1 are small, compared with the present invention, making identification of mutation nearly impossible, as does the two-dimensional array probes. Furthermore, when signal components, noise components and S/N ratio are obtained in the same manner as in the present invention, the signal components are 182.3, the noise components are 57.8, and the S/N ratio is 3.15. However, there is the drawback that variations in the signal components for the spots of the same type are as large as 25.6%.

### SUMMARY

Table 4 summarizes the detection capability of the DNA chip of the present invention having a three-dimensional probe array and a controlled spot thickness, the DNA chip of Comparative Example 1 having a two-dimensional probe array, and the DNA chip of Comparative Example 2 having a three-dimensional probe array, but having an uncontrolled spot thickness, which have been compared as above. Shortcomings concerned with the above-described problems are marked with a cross (X).

TABLE 4
Comparison of detection capability of each DNA chip

| | Three-dimensional array of probes | | |
|---|---|---|---|
| | Present invention | | |
| | (controlled spot | Uncontrolled | Two-dimensional |
| | thickness) | spot thickness | array of probes |
| Identification | ◯ | X | X |
| of point | | (unidentifiable) | (unidentifiable) |
| mutation | | | |
| Signal | 133.7 | 182.3 | 5.3X |
| components | | | |
| Noise | 37.6 | 57.8 | 30.7 |
| components | | | |
| S/N ratio | 3.56 | 3.15 | 0.17X |
| Variations in | 5.5% | 25.6%X | 5.2% |
| signal | | | |
| components | | | |

The above improvements in the detection capability of the DNA chip of the present invention are found to be achieved for the following two reasons:
In the present invention, as compared with the DNA chip in the two-dimensional probe array, signal components are markedly increased, but noise components are not increased too greatly, so that the S/N ratio increases remarkably.
In the present invention, variations in signal components are small, in comparison with the DNA chip having a three-dimensional probe array, but having an uncontrolled spot thickness.

The marked increase in signal components in the present invention is ascribed to the facts that the probes are arranged three-dimensionally within the porous particles, and the number of the probes per unit projected area to the substrate is remarkably increased compared with the two-dimensional array, and that the porous particles transparent to exciting light are used, so that exciting light is shone, without attenuation, at the probes within the porous particles. It has been confirmed that if the linear absorption coefficient of the porous particles for exciting light becomes greater than 10 μm⁻¹, attenuation of exciting light within the porous particles increases, with the result that fluorescence intensity decreases noticeably to a level almost identical with that of the two-dimensional probe array DNA chip. Hence, it is essential to use porous particles having a linear absorption coefficient, for exciting light, of 10 μm⁻¹ or less.

The small increase in noise components, on the other hand, is attributed to the full suppression of nonspecific adsorption which may be increased by rendering the array of probes three-dimensional. The full suppression is considered to have resulted from the facts that nonspecific adsorption sites in the probe molecules and the surfaces of the porous particles were fully capped during probe synthesis, and that cleaning after the hybridization reaction was effected appropriately.

The decrease in variations in signal components according to the present invention is due to the fact that when the probe-bearing porous particles are immobilized on the substrate to form spots, the probe-bearing porous particles are arranged in a single layer to suppress variations in the thickness of the spots. By so doing, the number of the probes is controlled stably, and the hybridization reaction using a cover glass can be performed uniformly.

As described above, the DNA chip of the present invention can show a high detection capability not only by increasing the number of probes according to a three-dimensional array, but also by taking a spot form capable of stably controlling signal components from the increased probes.

In the light of the foregoing outcomes and discussion, the use of the DNA chip of the present invention makes it possible to perform, for example, the analysis of monobasic polymorphism which requires that small differences in signals be discriminated.

### Example 2

The spotter of the present invention will be described concretely with reference to the accompanying drawings. However, the present invention is not limited to the embodiments described below.

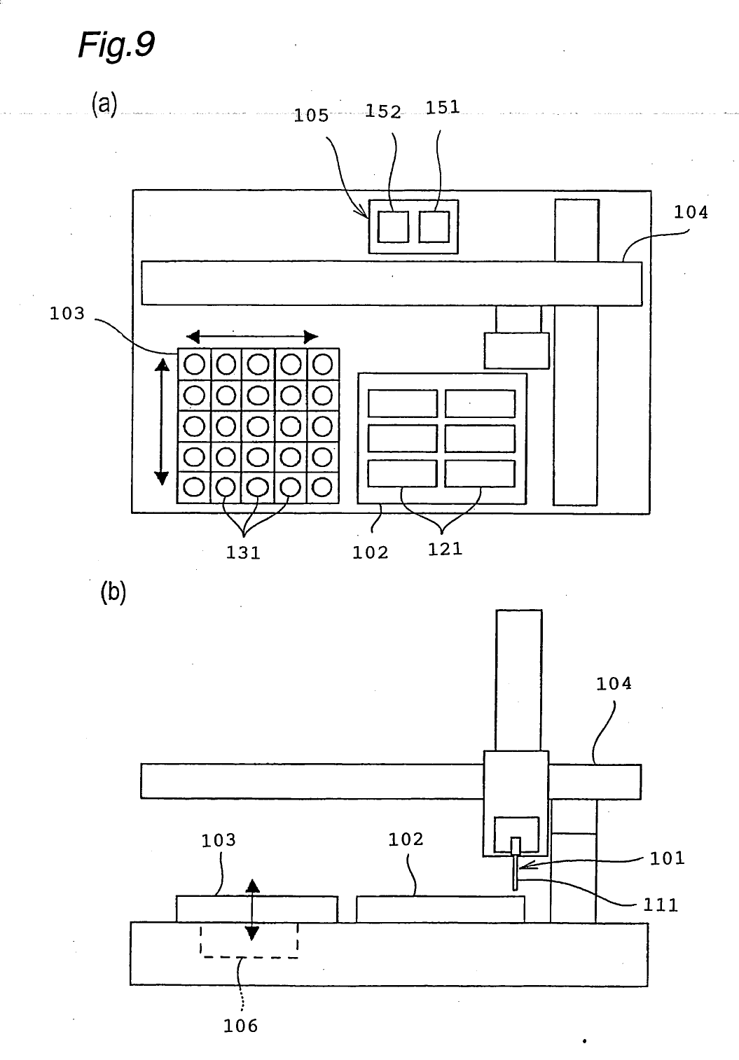

FIG. 9(a) is a schematic plan view showing a spotter according to a first embodiment of the present invention. FIG. 9(b) is a schematic side view of the spotter shown in FIG. 9(a).

As shown in FIGS. 9(a) and 9(b), this spotter is mainly composed of five portions, i.e., a spotting head 101, a substrate fixing portion 102, a container accommodation portion 103, a spotting head moving robot 104, and a spotting head cleaning portion 105. The features and roles of the respective portions will be described below.

(1) Spotting Head

The spotting head 101 is furnished with a capillary 111 which sucks in a spotting solution by capillarity. The capillary 111 is a slender tubular member extending in a vertical direction. By bringing the tip of the capillary 111 into contact with the surface of a substrate (reactive detection chip) 121, spotting is performed to place the solution containing a plurality of particles on a part of the substrate 121.

(2) Substrate Fixing Portion

The substrate fixing portion 102 is adapted to fix the position of a plurality of the substrates 121 to be spotted on.

(3) Container Accommodation Portion

The container accommodation portion 103 accommodates a plurality of cylindrical containers 131 containing various spotting solutions. Each spotting solution contains particles such as porous particles (for example, porous glass). A motion imparting mechanism 106 for maintaining the dispersibility of the particles in the spotting solution is provided below the container accommodation portion 103.

(4) Spotting Head Moving Robot

The spotting head moving robot 104 has the function of moving the spotting head 101 to an arbitrary position. In connection with a horizontal direction, a positional accuracy corresponding to the pitch of spots, namely, a positional accuracy of the order of several tens of micrometers, is required. The basic configuration of the spotting head moving robot 104 is comparable to that of a three-axis (XYZ-axis) robot used in a drive unit or the like of a plotter.

(5) Spotting Head Cleaning Portion

The spotting head cleaning portion 105 is designed to clean off the spotting solution, which remains in the inside and outside of the capillary 111, in order to prevent mixing of different spotting solutions. The spotting head cleaning portion 105 also has the function of drying the capillary 111 after cleaning off the spotting solution.

The features which require a more detailed explanation will be additionally described below.

Spotting Head 101

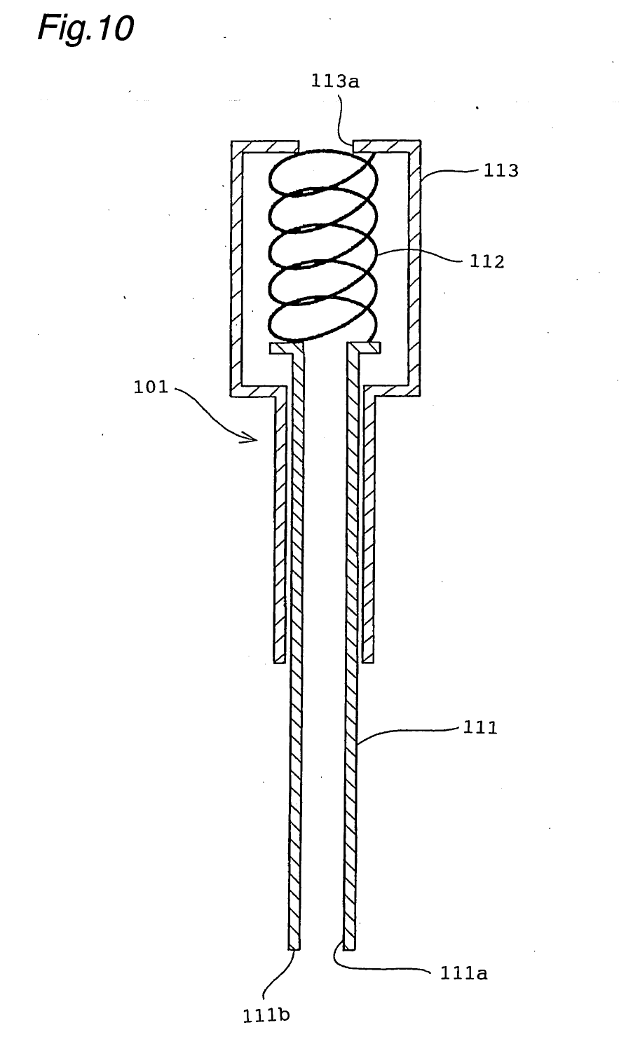

FIG. 10 is an enlarged sectional view showing the spotting head 101. The spotting head 101 is equipped with the above-mentioned capillary 111, and a casing 113 housing an upper half of the capillary 111. A spring 112 is built into the casing 113, and the capillary 111 is pushed downward by the spring 112. When a tip surface 111b of the capillary 111 is pressed against the substrate 121 by the action of the spring 112, the contact force of the capillary 111 on the substrate 121 can be stabilized.

The spotting head 101 is hollow, and a gas such as air is supplied through an opening 113a provided at the top of the casing 113 into the spotting head 101. By adjusting the strength of its air stream, the spotting solution inside the capillary 111 is completely excluded, or the spotting solution having risen upward is pressed down to the tip surface 111b of the capillary 111.

A required number of spots are formed by spotting within a period of time within which the particles of the spotting solution settle in the capillary 111. Once the particles have settled down, the spotting solution is discarded, or the spotting solution is returned into the container 131. The spotting solution keeping the particles dispersed is sucked out of the container 131 into the capillary 111 to continue spotting.

If the lowermost surface of the spotting solution sucked into the capillary 111 is higher than the tip surface 111b of the capillary 111, the problem arises that spotting cannot be effected even upon contact of the tip surface 111b of the capillary 111 with the surface of the substrate 121. As a means of preventing this problem, it is conceivable to flow a gas, such as air, into the capillary 111 moderately through the opening 113a, as described above. However, this problem can be dealt with by increasing the wettability, by the spotting solution, of only an internal wall 111a and the annular tip surface 111b at the front end of the capillary 111, in comparison with other portions of the capillary 111.

Container Accommodation Portion 103

The whole of the container accommodation portion 103 accommodating the containers 131 is vibrated using the motion imparting mechanism 106 which is composed of an ordinary shaker. The directions of vibration of the container accommodation portion 103 are a horizontal direction and a vertical direction, as indicated by arrows in FIGS. 9(a) and 9(b). The intensity of the vibrations is a level enough to maintain the dispersed state of the particles contained in the spotting solution, and depends on the size and concentration of the particles contained in the spotting solution. When the spotting solution is to be transferred between the container 131 and the spotting head 101, vibrations of the container accommodation portion 103 are transiently stopped, and the container accommodation portion 103 is caused to rest at the original position. Alternatively, with the container accommodation portion 103 being kept vibrated, alignment is performed such that the capillary 111 of the spotting head 101 moves up and down in a zone where the opening portion of each vibrating container 131 always exists when viewed from above.

A lid is provided on the opening portion of the container 131. When the container 131 is moved, the lid is closed to prevent leakage of the spotting solution. When the spotting solution is transferred between the spotting head 101 and the container 131, the lid is opened. By so doing, the container accommodation portion 103 can be vibrated more vigorously. Further, the container 131 may be fixed to the container accommodation portion 103 so as not to be released from the container accommodation portion 103, and the container accommodation portion 103 may be rotated or turned upside down in a vertical plane. In this case, motions for maintaining particle dispersion, such as rotations or upside-down turns in the vertical plane, can be imparted to each container 131.

Spotting Head Cleaning Portion 105

Ethanol is sucked from an ethanol-holding cleaning container 151 into the capillary 111, for example, by utilization of capillarity. Then, the spotting head 101 is moved to a removal area 152, and a gas, such as air, is strongly blown toward the opening 113a of the spotting head 101 to discharge ethanol at a stroke, thereby cleaning the interior and exterior of the capillary 111. Then, the gas is further blown to dry the interior and exterior of the capillary 111.

Next, a second embodiment of the spotter according to the present invention will be described.

The basic structure of the present embodiment is the same as that of the first embodiment, but the spotting head 101 of the present embodiment is of a pin type. An ordinary, commercially available product for spotting can be used as this pin.

The spotting solution is adhered to the tip of the pin by utilization of wettability. Then, the tip of the pin is brought into contact with the substrate 121 to form a spot. After one spot is formed, the tip of the pin is placed in the spotting head cleaning portion 105, where it is ultrasonically cleaned and dried. If a new spot is to be formed, adhesion of the spotting solution to the pin tip, and contact of the pin tip with the substrate 121 are repeated as desired.

With this method, only one spot can be formed by each supply of the spotting solution to the spotting head 101, and the treating time is long. However, this method is a reliable method which forms stable spots with few variations. It is important to determine the shape of, the size of, and the material for, the pin tip in accordance with the properties of the spotting solution and the size of spots to be formed.

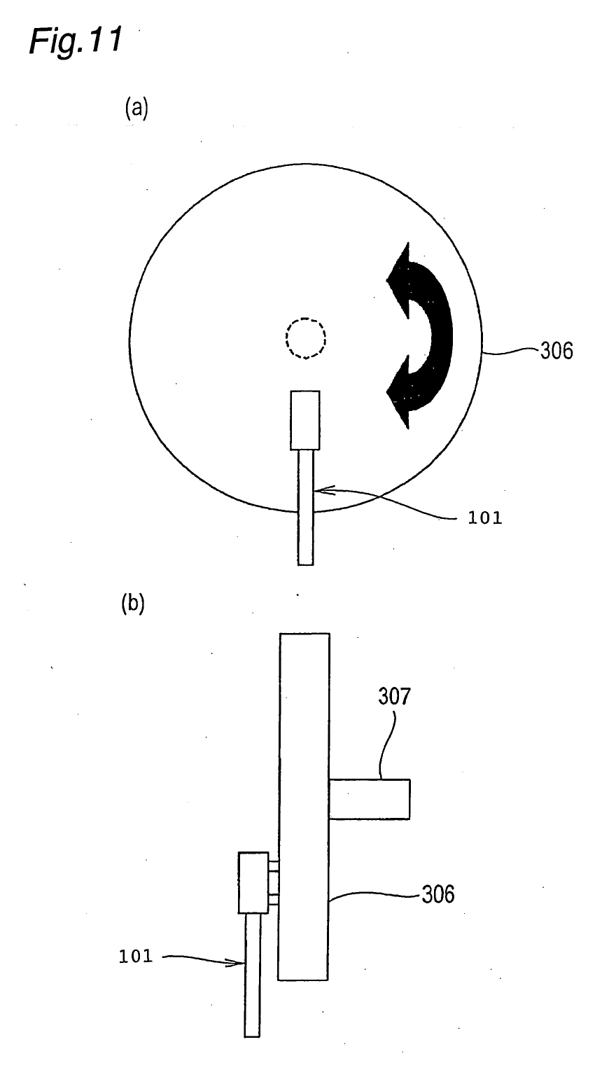

Next, a third embodiment of the spotter of the present invention will be described with reference to FIGS. 11(a) and 11(b). The basic structure of the present embodiment is the same as that of the first embodiment, but the spotter of the present embodiment is equipped with a motion imparting mechanism for shaking the spotting solution in the spotting head.

The present embodiment adds the function of turning the spotting head 101 upside down to the constitution of the first embodiment. As shown in FIGS. 11(a) and 11(b), the spotting head 101 is fixed to an upside-down turning plate (motion imparting mechanism) 306. The upside-down turning plate 306 is connected to a drive source such as a motor (not shown), and the upside-down turning plate 306 is caused by the drive source to rotate about a shaft 307 through a clockwise half-turn and a counterclockwise half-turn alternately in a vertical plane. These upside-down turns are made between spotting actions to such a degree that the dispersed state of the particles of the spotting solution in the capillary 111 is maintained. Concretely, spotting is performed for 30 seconds, and then spotting is suspended for 20 seconds, during which time upside-down turning motions are made once in 2 seconds.

The upside-down turning motions of the spotting head 101 maintain the dispersed state of the particles in the spotting solution sucked into the capillary 111, and thus there is no need to discharge the spotting solution halfway through the spotting action. The method of moving the spotting head 101 is not limited to the upside-down turning motions, but may be rotary motions in a vertical plane. Since the particles in the spotting solution settle under the action of gravity, any member whose vibration component in the vertical direction is greater than a certain value can be used as the motion imparting mechanism.

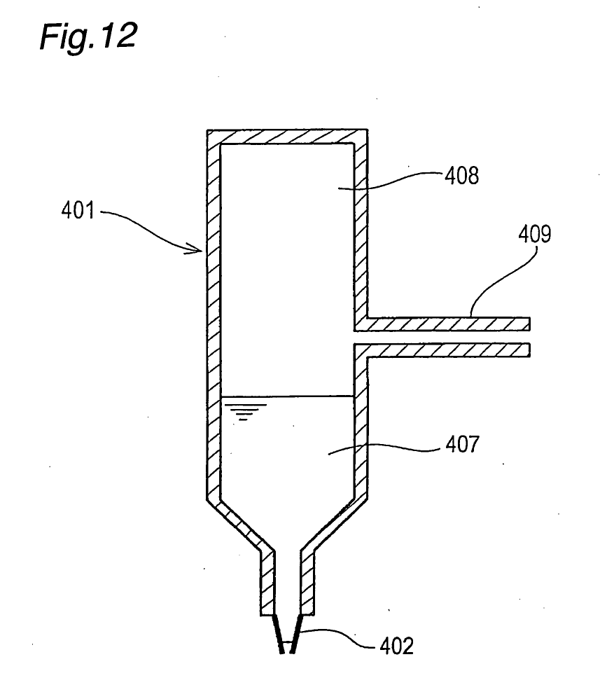

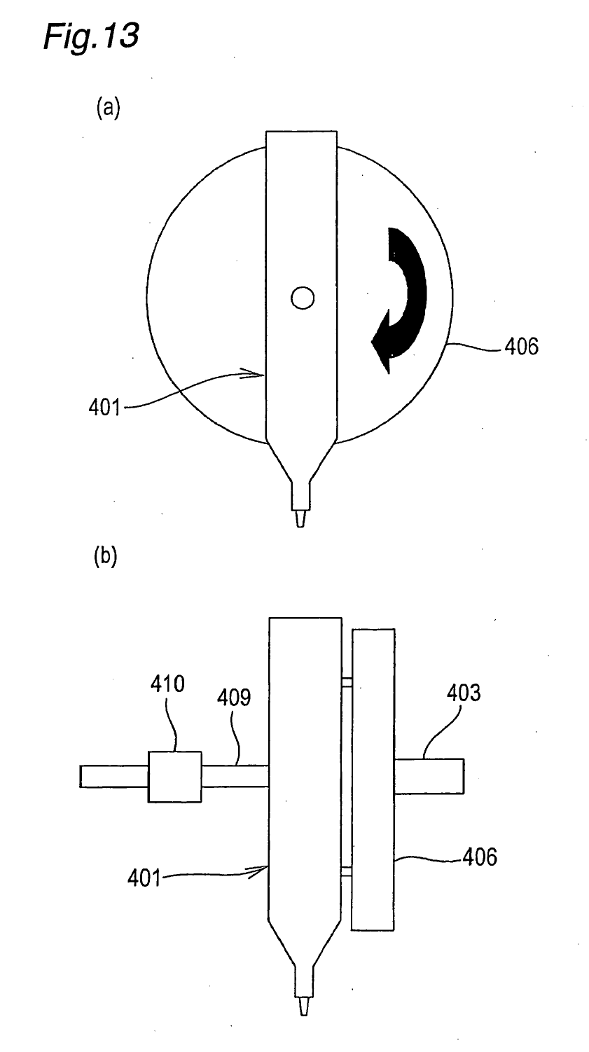

Next, a fourth embodiment of the spotter according to the present invention will be described with reference to FIG. 12, FIG. 13(a) and FIG. 13(b).

The basic structure of the present embodiment is practically the same as that of the first embodiment, but the spotter of the present embodiment is equipped with a motion imparting mechanism for moving the spotting solution in the spotting head, as in the third embodiment.

As shown in FIG. 12, a spotting head 401 of the spotter of the present embodiment has a cylinder 408 storing a spotting solution 407. A gas, such as air, is fed into the cylinder 408 through a tube 409 to exert a pressure on the spotting solution 407. By this measure, a trace amount of the spotting solution 407 is jetted at the substrate 121 (see FIG. 9(a)) through a nozzle 402 provided at the lower end of the cylinder 408.

Impartment of a motion to the spotting solution 407 in the spotting head 401 is performed by rotating the spotting head 401 in a vertical plane. Concretely, as shown in FIGS. 13(a) and 13(b), the spotting head 401 is fixed to a rotating plate (motion imparting mechanism) 406 which rotates about a shaft 403 in a vertical plane, and the gas is fed into the cylinder 408 via a rotary joint 410 provided on the tube 409. The rotating plate 406 is rotated by a drive source such as a motor (not shown).

To inject the spotting solution 407 into the cylinder 408, the spotting solution stored in the container 131 (see FIG. 9(a)) may be sucked into the spotting head 401, or a prepared spotting solution 407 may be directly poured into the cylinder 408. In the latter case, settlement of the particles may proceed to some degree in the stationary cylinder 408. In this case, the spotting solution 407 is shaken vigorously enough to disperse the particles in the spotting solution 407 again. With the spotting head of a cylinder-contained type as in the present embodiment, it is easy to take a measure for preventing the spotting solution from leaking when vigorous vibrations are given, in comparison with the spotting head of the type holding the spotting solution in the capillary as shown in the third embodiment.

The mode of imparting a motion to the spotting solution 407 in the spotting head 401 is not limited to a rotary motion in the vertical plane, but may be the upside-down turning of the spotting head 401 as in the third embodiment. In this case, if some margin is allowed for the length of the tube 409, the rotary joint 410 is not necessary. Since the particles in the spotting solution settle under the action of gravity, any member whose vibration component in the vertical direction is greater than a certain value can be used as the motion imparting mechanism.

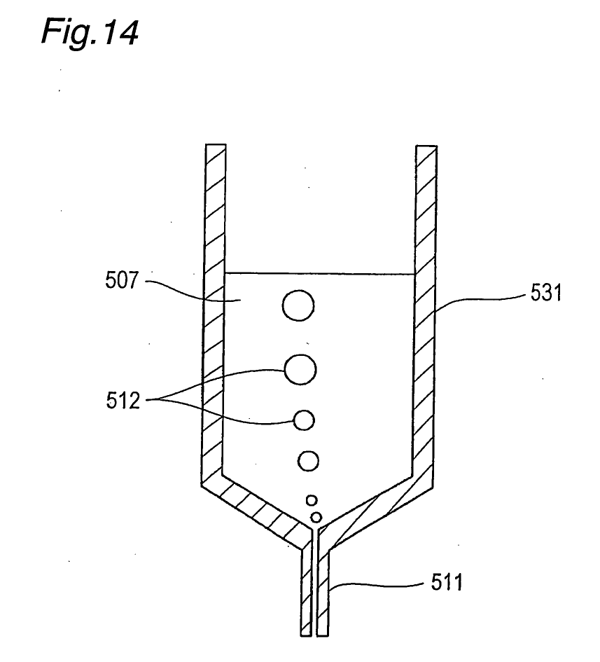

Next, a fifth embodiment of the spotter according to the present invention will be described with reference to FIG. 14. The basic structure of the present embodiment is the same as that of the first embodiment, but the present embodiment is configured to feed a gas into the container for bubbling in order to maintain the dispersibility of the particles in the spotting solution.

As shown in FIG. 14, a thin pipe 511 is connected to the bottom of a container 531. A gas, such as air or nitrogen, is fed through the thin pipe 511 into a spotting solution 507 within the container 531 to generate bubbles 512. As the bubbles 512 ascend, the particles which are settling in the spotting solution 507 also go up. Thus, the dispersibility of the particles in the spotting solution 507 can be maintained.

In feeding the gas, it is important to feed a small amount of the gas at a pressure of a certain value or higher. This is preferably done by a tube pump or an air pump having a low amount of flow. The flow rate of the gas is preferably adjusted at a minimum within a range in which the dispersibility of the particles can be maintained. This flow rate of the gas depends on the size, specific gravity, and concentration of the particles, and the specific gravity of the liquid used in dispersion. The internal diameter of the thin pipe 511, which determines the size of the bubbles, is selected, as desired, so that a satisfactory dispersed state of the particles can be achieved. Alternatively, a porous filter may be attached to a front end portion of the thin pipe 511 to adjust the size of the bubbles.

To prevent the spotting solution 507 from being pulled into the thin pipe 511 by capillarity when feeding of the gas is stopped, the thin pipe 511 is preferably formed from a material having low wettability by the spotting solution 507. A general problem during bubbling is that the gas fed helps evaporate the liquid used in dispersion of the particles. To prevent this problem, it is advisable to feed a gas containing a large amount of a volatile component of the liquid. If the liquid is water, for example, the above problem can be solved by feeding humid air containing a large amount of a water vapor.

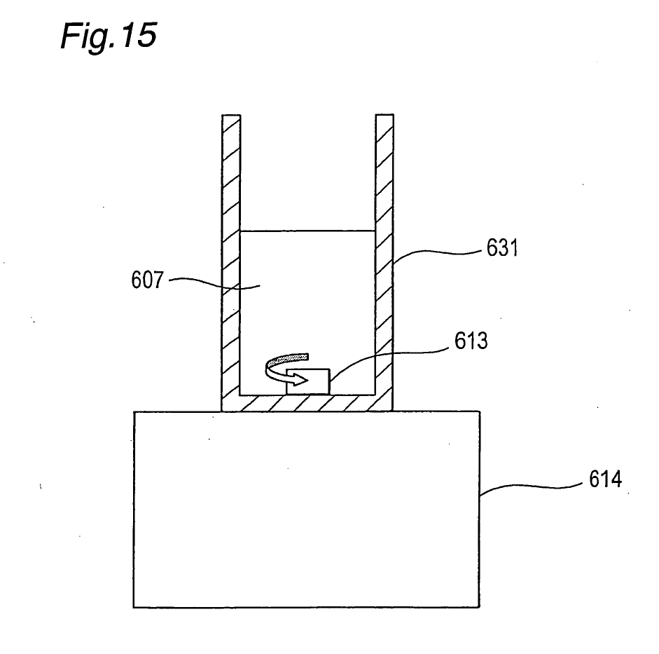

Next, a sixth embodiment of the spotter according to the present invention will be described with reference to FIG. 15. The basic structure of the present embodiment is the same as that of the first embodiment of the spotter according to the present invention, but the present embodiment is configured to stir the spotting solution by a magnetic stirrer, in order to maintain the dispersibility of the particles in the spotting solution.

As shown in FIG. 15, a micro-rotor 613 is disposed in a spotting solution 607 stored in a cylindrical container 631, and the micro-rotor 613 is in contact with the bottom of the container 631. The micro-rotor 613 comprises a magnet coated on its outer surface with a fluoroplastic, and has a cylindrical shape of 2 mm in diameter and 2 mm in height. The size of the micro-rotor 613 is smaller than the inner diameter of the bottom of the container 631, and the micro-rotor 613 can freely rotate within the container 631 during stirring.

The container 631 is fixed onto a compact magnetic stirrer 614. The material for the container 631, and its way of fixing should be selected so that a magnetic field from the magnetic stirrer 614 is not blocked. The rotational speed of the magnetic stirrer 614 is set, as appropriate, at a minimum which enables the dispersibility of the particles in the spotting solution 607 to be maintained. The stirring ability can be enhanced by increasing the rotational speed of the magnetic stirrer 614 (micro-rotor 613). Alternatively, the stirring ability can be improved by increasing the number of the micro-rotors 613 disposed in the spotting solution 607.

### INDUSTRIAL APPLICABILITY

In the reactive detection chip such as a DNA chip, the probes are disposed inside the porous particles transparent to exciting light. As a result, exciting light is shone, without attenuation, at the probes increased in number three-dimensionally. Thus, signals in the detection of the fluorescent dye-labeled sample are markedly increased. Furthermore, when the probe-bearing porous particles are immobilized on the substrate to form spots, these particles are arranged in a single layer, so that variations in signals due to variations in the thicknesses of the spots can be suppressed. Consequently, the S/N ratio is stably increased, thus enhancing the detection capability of the reactive detection chip. Besides, the reactive detection chip of the present invention can be efficiently manufactured with the use of the spotter of the present invention which has the function of maintaining the dispersibility of the particles contained in the spotting solution.

1. A reactive detection chip having spots formed by immobilizing a plurality of porous particles in a cluster onto a substrate, the porous particles having probe molecules bound to surfaces of the porous particles and surfaces of pores in the particles,
wherein the porous particles are transparent to incident light for detection, and the porous particles have been immobilized in a single-layered state onto the substrate.

2. The reactive detection chip according to claim 1, which is arranged to detect sample molecules bound to the probe molecules by irradiating the spots with the incident light.

3. The reactive detection chip according to claim 1 or 2, wherein the sample molecules have optically detectable molecules added thereto, and which detects the optically detectable molecules.

4. The reactive detection chip according to claim 3, wherein the sample molecules have fluorescent dye molecules added thereto, and which detects fluorescence from the fluorescent dye molecules.

5. The reactive detection chip according to claim 1, wherein a linear absorption coefficient of the porous particles for the incident light is 10 μm⁻¹ or less.

6. The reactive detection chip according to claim 1 or 5, wherein a linear absorption coefficient of the substrate for the incident light is 100 μm⁻¹ or more.

7. The reactive detection chip according to claim 1, wherein a particle size of the porous particles is 0.1 μm or more, but 200 μm or less.

8. The reactive detection chip according to claim 1, wherein a diameter of the spots comprising the porous particles is 10 μm or more, but 1,000 μm or less.

9. The reactive detection chip according to claim 1, which is prepared by forming a thermoplastic organic film on the substrate, applying the porous particles in a spotty form onto the organic film, heating the substrate to soften the organic film, thereby embedding the porous particles in the organic film for immobilizing the porous particles, and removing a surplus of the porous particles which have not been immobilized.

10. The reactive detection chip according to claim 9, wherein a thickness of the organic film is smaller than a half of a particle size of the porous particles.

11. The reactive detection chip according to claim 9, wherein the organic film is formed by spin-coating a material for the organic film dissolved in an organic solvent.

12. The reactive detection chip according to 9, wherein the spotty-form application is performed, with the porous particles being dispersed in a liquid.

13. The reactive detection chip according to claim 9, wherein the removal of the surplus of the porous particles is performed by ultrasonic cleaning.

14. The reactive detection chip according to claim 9, wherein the organic film is a vinyl acetate film.

15. The reactive detection chip according to claim 1, wherein the probe molecules are one of a nucleic acid, a protein, and a glycoprotein.

16. A method for manufacturing a reactive detection chip, comprising the steps of:
binding probe molecules to surfaces of porous particles and surfaces of pores in the particles to form probe molecule-bearing porous particles;
forming a thermoplastic organic film on a substrate;
applying the probe molecule-bearing porous particles in a spotty form onto the organic film;
heating the substrate to soften the organic film, thereby embedding the probe molecule-bearing porous particles in the organic film for immobilizing the probe molecule-bearing porous particles onto the substrate; and
removing a surplus of the probe molecule-bearing porous particles which have not been immobilized.

17. A spotter comprising:
a spotting head for spotting a liquid containing a plurality of particles onto a substrate; and
a motion-imparting mechanism for imparting a motion to the liquid to maintain a dispersed state of the particles in the liquid.

18. The spotter according to claim 17, further comprising
a container for accommodating the liquid and supplying the liquid to the spotting head, and
wherein the motion-imparting mechanism imparts the motion to the liquid in the container.

19. The spotter according to claim 17, wherein the motion-imparting mechanism moves the spotting head accommodating the liquid.

20. The spotter according to claim 18, wherein the motion includes vibrations in a vertical direction.

21. The spotter according to claim 18, wherein the motion includes rotations in a vertical plane.

22. The spotter according to claim 18, wherein the motion includes upside-down turns.

23. The spotter according to 18, wherein the motion-imparting mechanism feeds a gas into the liquid accommodated in the container for bubbling, thereby maintaining the dispersed state of the particles in the liquid.

24. The spotter according to claim 18, wherein the motion-imparting mechanism is a magnetic stirrer for rotating a rotor disposed in the container to stir the liquid in the container.

25. A reactive detection chip prepared using the spotter of claim 17.

26. A method for arranging particles, comprising:
making ready for use a liquid incorporating a plurality of particles;
imparting a motion to the liquid to maintain a dispersed state of the plural particles in the liquid so that the plural particles do not agglomerate; and
arranging the liquid containing the plural particles on a substrate by use of a spotting head.


SEQUENCE LISTING (7 sequences)

SEQ ID NO: 1 - DNA, 20 bp, Artificial Sequence
  Probe for microchip
atgggcctccggttcatgcc

SEQ ID NO: 2 - DNA, 20 bp, Artificial Sequence
  Probe for microchip
atgggcctccagttcatgcc

SEQ ID NO: 3 - DNA, 20 bp, Artificial Sequence
  Probe for microchip
atgggcctctggttcatgcc

SEQ ID NO: 4 - DNA, 20 bp, Artificial Sequence
  Probe for microchip
tacccggaggccaagtacgg

SEQ ID NO: 5 - DNA, 20 bp, Artificial Sequence
  Probe for microchip
tacccggaggtcaagtacgg

SEQ ID NO: 6 - DNA, 20 bp, Artificial Sequence
  Probe for microchip
tacccggagaccaagtacgg

SEQ ID NO: 7 - DNA, 20 bp, Artificial Sequence
  Probe for microchip
tttttttttttttttttttt